(19) United States
(12) Patent Application Publication
(10) Pub. No.: US 2026/0112384 A1
(43) Pub. Date: Apr. 23, 2026

(54) METHOD AND APPARATUS FOR AUDIO SEPARATION, DEVICE, AND PRODUCT

(71) Applicant: Beijing Zitiao Network Technology Co., Ltd., Beijing (CN)

(72) Inventor: Shichao GE, Beijing (CN)

(21) Appl. No.: 19/301,233

(22) Filed: Aug. 15, 2025

(30) Foreign Application Priority Data
Oct. 17, 2024 (CN) 202411456013.X

(51) Int. Cl. G10L 21/028; G10L 15/06; G10L 25/18; G10L 25/30

(52) U.S. Cl. CPC G10L 21/028; G10L 15/063; G10L 25/18; G10L 25/30

(57) ABSTRACT

The present disclosure relates to a method and apparatus for audio separation, a device, and a product. The method includes: generating, by an encoder, a time-domain feature and a frequency-domain feature of vocal audio based on the vocal audio. The method further includes: generating, by a network with an attention mechanism, a fused feature based on the time-domain feature and the frequency-domain feature. In addition, the method further includes: generating, by a decoder, separated audio based on the fused feature, where the separated audio includes at least one of dry vocal audio or reverberant vocal audio.

### CROSS-REFERENCE TO RELATED APPLICATION(S)

This application claims priority to Chinese Application No. 202411456013.X filed Oct. 17, 2024, the disclosure of which is incorporated herein by reference in its entireties.

FIELD The present disclosure relates to the field of computers, and more particularly, to a method and apparatus for audio separation, a device, and a product.

### BACKGROUND

Music source separation (MSS) refers to a process of separating, through a series of processing technologies, a plurality of independent music source audio signals from a piece of audio that is mixed with different music sources. In the music industry, the music source separation technology is widely used in music production and editing processes, and can extract audio tracks of different musical instruments from mixed music, such as vocals, drums, bass, etc., to enable musicians to fine-tune and control music elements.

Conventional music source separation methods are mainly based on signal processing technologies, such as filter design, time-frequency analysis, etc. In recent years, deep learning has made significant progress in the field of music source separation. Efficient separation of complex audio signals can be achieved by training deep neural network models. Deep learning methods have powerful feature extraction and pattern recognition capabilities to handle more complex audio environments.

### SUMMARY

According to a first aspect of embodiments of the present disclosure, a method for audio separation is provided. The method includes: generating, by an encoder, a time-domain feature and a frequency-domain feature of vocal audio based on the vocal audio. The method further includes: generating, by a network with an attention mechanism, a fused feature based on the time-domain feature and the frequency-domain feature. In addition, the method further includes: generating, by a decoder, separated audio based on the fused feature, where the separated audio includes at least one of dry vocal audio or reverberant vocal audio.

According to a second aspect of embodiments of the present disclosure, an apparatus for audio separation is provided. The apparatus includes a time-frequency-domain feature generation module configured to generate, by an encoder, a time-domain feature and a frequency-domain feature of vocal audio based on the vocal audio. The apparatus further includes a fused feature generation module configured to generate, by a network with an attention mechanism, a fused feature based on the time-domain feature and the frequency-domain feature. In addition, the apparatus further includes a separated audio generation module configured to generate, by a decoder, separated audio based on the fused feature, where the separated audio includes at least one of dry vocal audio or reverberant vocal audio.

According to a third aspect of embodiments of the present disclosure, an electronic device is provided. The electronic device includes one or more processors; and a storage apparatus configured to store one or more programs, where the one or more programs, when executed by the one or more processors, cause the one or more processors to implement an method for audio separation. The method includes: generating, by an encoder, a time-domain feature and a frequency-domain feature of vocal audio based on the vocal audio. The method further includes: generating, by a network with an attention mechanism, a fused feature based on the time-domain feature and the frequency-domain feature. In addition, the method further includes: generating, by a decoder, separated audio based on the fused feature, where the separated audio includes at least one of dry vocal audio or reverberant vocal audio.

According to a fourth aspect of embodiments of the present disclosure, a computer program product is provided. The computer program product is tangibly stored on a non-transitory computer-readable medium and includes machine-executable instructions that, when executed, cause a machine to implement a method for audio separation. The method includes: generating, by an encoder, a time-domain feature and a frequency-domain feature of vocal audio based on the vocal audio. The method further includes: generating, by a network with an attention mechanism, a fused feature based on the time-domain feature and the frequency-domain feature. In addition, the method further includes: generating, by a decoder, separated audio based on the fused feature, where the separated audio includes at least one of dry vocal audio or reverberant vocal audio.

The section Summary is provided to introduce a selection of concepts in a simplified form, which will be further described in the detailed description below. The section Summary is neither intended to identify key features or principal features of the claimed subject matter, nor to limit the scope of the claimed subject matter.

### BRIEF DESCRIPTION OF THE DRAWINGS

The abovementioned and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 is a schematic diagram of an example environment in which a plurality of embodiments of the present disclosure can be implemented;

FIG. 2 is a flowchart of a method for audio separation according to some embodiments of the present disclosure;

FIG. 3 is a flowchart of an example process for audio separation according to some embodiments of the present disclosure;

FIG. 4 is a schematic diagram of an example in which a fused feature is obtained by a network with a multi-head attention mechanism according to some embodiments of the present disclosure;

FIG. 5 is a schematic diagram of an example of a network with a multi-head attention mechanism according to some embodiments of the present disclosure;

FIG. 6A and FIG. 6B are schematic diagrams of example processes of obtaining dry audio or reverberant audio based on wet audio according to some embodiments of the present disclosure;

FIG. 7A is a schematic diagram of an example process of training an audio separation model based on a loss between dry audio and target dry audio according to some embodiments of the present disclosure.

FIG. 7B is a schematic diagram of an example process of training an audio separation model based on a loss between reverberant audio and target reverberant audio according to some embodiments of the present disclosure;

FIG. 8 is a block diagram of an apparatus for audio separation according to some embodiments of the present disclosure; and

FIG. 9 is a block diagram of a device capable of implementing a plurality of embodiments of the present disclosure.

### DETAILED DESCRIPTION OF EMBODIMENTS

It may be understood that all user-related data involved in the technical solutions should be obtained and used with the authorization of the user. It means that in the technical solutions, if personal information of the user needs to be used, explicit consent and authorization of the user are required before the data is obtained, otherwise the collection and use of the related data will be disallowed. It should also be understood that during implementation of the technical solutions, the collection, use, and storage of data should strictly comply with relevant laws and regulations, necessary technologies and measures should be used to ensure the security of the user data and ensure safe use of the data.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree”or “disagree”to provide the personal information to the electronic device.

It can be understood that the abovementioned process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may be included below.

As described above, extracting different audio tracks from mixed music makes it easy for musicians to adjust and control music elements. For example, when a cover version of a song is created, it is often necessary to perform reverb processing on a covered vocal, because reverberation can simulate natural reflection of a sound in a particular environment, thereby increasing spatial sense and depth of the music. To make the covered vocal have the same reverberation effect as a vocal in an original track, audio with a reverberation effect needs to be separated from the original track, so that the reverb processing is performed on the covered vocal by using the audio with a reverberation effect.

However, conventional music source separation technologies such as filter processing, when separating a dry vocal signal and a reverberant vocal signal, often lead to loss of sound quality, resulting in increased background noise or audio distortion. On the other hand, there are related technologies that rely on specific assumptions or parameter settings, limiting their application flexibility on different types of audio materials. In addition, while some deep learning technologies have made some progress in separating audio through convolutional layers, in the face of long-distance dependencies, these technologies show significant shortcomings that make it difficult to handle longer-lasting audio materials.

To make a covered vocal have a reverberation effect close to that of a vocal in an original track, the present disclosure provides a method for audio separation. A time-domain feature and a frequency-domain feature in vocal audio are extracted simultaneously by an encoder, and the time-domain feature and the frequency-domain feature are fused by a network with an attention mechanism. Next, a decoder generates separate audio based on a fused feature. Through the audio separation manner with an attention mechanism, an ability of an audio separation model to distinguish between a vocal component and a reverberation component can be enhanced, thereby improving accuracy of separating a vocal and reverberation from an audio track. In addition, in this audio-based separation method, separated reverberant audio or separated dry vocal audio can be kept with sound quality close to that of vocal audio while audio is successfully separated, thereby improving user experience.

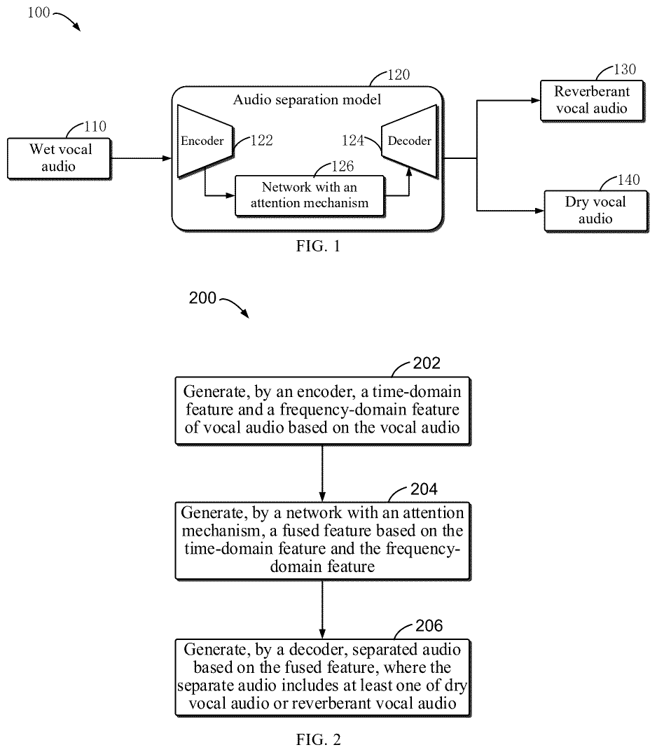

FIG. 1 is a schematic diagram of an example environment 100 in which a plurality of embodiments of the present disclosure can be implemented. Referring to FIG. 1, to achieve precise audio separation, the present disclosure does not employ a conventional music source separation technology, but rather uses an audio separation model 120 with an attention mechanism to achieve separation of wet vocal audio 110. In some embodiments, the wet vocal audio 110 may be vocal audio with a reverberation effect that is separated from an original track. In some embodiments, before the wet vocal audio 110 is sent to the audio separation model 120, an expression of the wet vocal audio 110 in a time-frequency domain may be obtained through a short-time Fourier transform.

As shown in FIG. 1, the audio separation model includes an encoder 122, a network 126 with an attention mechanism, and a decoder 124. In some embodiments, the encoder 122 may include a convolutional layer and two layers of feature processing modules. The convolutional layer may be a 2D convolutional layer used to extract a local time-domain feature, because the 2D convolutional layer can capture changes in an audio signal at different frequencies over a short period of time.

In some embodiments, to enable the encoder 122 in the audio separation model 120 to better capture global time and frequency features in the wet vocal audio 110, the feature processing module may include an inverse time-frequency convolution block-time-distributed fully connected layer (TFC-TDF). A time-distributed fully connected layer (TDF) may be a plurality of linear layers connected in series, which may obtain, for a given frequency-domain signal, a dependency relationship between spectrums of a target signal, thereby enhancing an ability of the audio separation model 120 to process a long audio material. In some embodiments, the time-distributed fully connected layer (TDF) may be a sequence consisting of two linear layers. An inverse time-frequency convolution block (TFC) is a specially designed convolution operation that can be used to simultaneously process features in time and frequency dimensions, and can further extract feature information in a time-frequency domain in audio, thereby helping the audio separation model 120 to better understand a characteristic and a structure of a sound.

In some embodiments, to abstract high-level time-domain and frequency-domain features and expand receptive fields in time and frequency domains, the feature processing module may also include a down-sampling layer (down-sampling). In some embodiments, information common to a time-domain feature and a frequency-domain feature may also be extracted during down-sampling, thereby enabling the audio separation model 120 to learn more abstract feature representations. In some embodiments, the down-sampling layer may also reduce dimensions of time and frequency features through operations such as pooling.

With continued reference to FIG. 1, to provide the audio separation model 120 with a stronger ability to process a long audio material, the audio separation model 120 may include the network 126 with an attention mechanism. In some embodiments, the network 126 with an attention mechanism may be a network of a U-Net structure with an attention mechanism, and time and frequency features processed by the encoder 122 are injected into the U-Net network with an attention mechanism, thereby improving signal-to-distortion ratio (SDR) performance of the audio separation model 120 in audio separation.

In some embodiments, a self-attention layer in the network 126 with an attention mechanism may use multi-head attention to process, in parallel, compressed, abstracted, and integrated time-domain and frequency-domain features obtained by the encoder 122, thereby improving a learning ability and processing efficiency of the audio separation model 120. In some embodiments, these features may first be segmented into a plurality of small chunks, so that multi-head self-attention can be used for each chunk, which enables each head to learn a different feature representation. In some embodiments, results of the multi-head processing may be merged, and then the segmented features may be fused by a linear transformation layer to obtain fused time-domain and frequency-domain features.

With continued reference to FIG. 1, when the fused time-domain and frequency-domain features are obtained, the decoder 124 may output separated audio. In some embodiments, the decoder 124 may have an up-sampling layer, an inverse time-frequency convolution block-time-distributed fully connected layer (TFC-TDF), and a 2D convolutional layer. In some embodiments, the decoder 124 in the audio separation model 120 may accept a feature at a corresponding encoding stage from the encoder 122 at each decoding stage, thereby helping the decoder 124 to recover detailed information of the audio. This can maintain separated reverberant vocal audio 130 or separated dry vocal audio 140 with sound quality similar to that of the wet vocal audio 110.

In some embodiments, if the audio separation model 120 is dedicated to separating reverberant audio, the reverberant vocal audio 130 may be obtained by the audio separation model 120. Conversely, if the audio separation model 120 is dedicated to separating dry audio, the dry vocal audio 140 may be obtained by the audio separation model 120. Alternatively, by inputting the wet vocal audio 110 into the audio separation model 120, the reverberant vocal audio 130 and the dry vocal audio 140 can also be obtained simultaneously.

Through the audio separation manner with an attention mechanism, an ability of an audio separation model to distinguish between a vocal component and a reverberation component can be enhanced, thereby improving accuracy of separating a vocal and reverberation from a vocal audio track. In addition, in this audio-based separation method, separated reverberant audio or separated dry vocal audio can be kept with sound quality close to that of vocal audio while audio is successfully separated, thereby improving user experience.

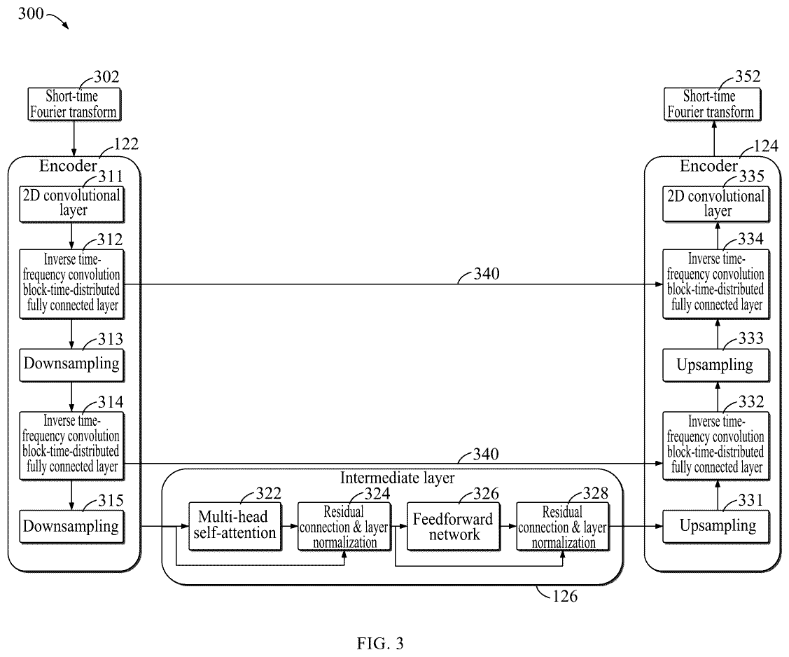

FIG. 2 is a flowchart of a method 200 for coordination between a plurality of warehouse robots according to some embodiments of the present disclosure. The method 200 may be performed by an apparatus for audio separation. The method 200 includes a block 202, a block 204, and a block 206.

As shown in FIG. 2, at the block 202, a time-domain feature and a frequency-domain feature of a vocal audio are generated by an encoder based on the vocal audio. Referring to FIG. 1, in some embodiments, the encoder 122 may include a convolutional layer and two layers of feature processing modules. The convolutional layer may be a 2D convolutional layer used to extract a local time-domain feature. In some embodiments, to enable the encoder 122 in the audio separation model 120 to better capture global time and frequency features in the wet vocal audio 110, the feature processing module may include an inverse time-frequency convolution block-time-distributed fully connected layer (TFC-TDF). A time-distributed fully connected layer (TDF) may be a plurality of linear layers connected in series, which may obtain, for a given frequency-domain signal, a dependency relationship between spectrums of a target signal, thereby enhancing an ability of the audio separation model 120 to process a long audio material. In some embodiments, the time-distributed fully connected layer (TDF) may be a sequence consisting of two linear layers. An inverse time-frequency convolution block (TFC) is a specially designed convolution operation that can be used to simultaneously process features in time and frequency dimensions, and can further extract feature information in a time-frequency domain in audio, thereby helping the audio separation model 120 to better understand a characteristic and a structure of a sound. In some embodiments, to abstract high-level time-domain and frequency-domain features and expand receptive fields in time and frequency domains, the feature processing module may also include a down-sampling layer (down-sampling). In some embodiments, information common to a time-domain feature and a frequency-domain feature may also be extracted during down-sampling, thereby enabling the audio separation model 120 to learn more abstract feature representations.

At the block 204, a fused feature is generated by a network with an attention mechanism based on the time-domain feature and the frequency-domain feature. With continued reference to FIG. 1, to enable the audio separation model 120 to have a stronger ability to process a long audio material, the network 126 with an attention mechanism may be a network of a U-Net structure with an attention mechanism, and time and frequency features processed by the encoder 122 are injected into the U-Net network with an attention mechanism, thereby improving signal-to-distortion ratio (SDR) performance of the audio separation model 120 in audio separation. In some embodiments, a self-attention layer in the network 126 with an attention mechanism may use multi-head attention to process, in parallel, compressed, abstracted, and integrated time-domain and frequency-domain features obtained by the encoder 122, thereby improving a learning ability and processing efficiency of the audio separation model 120. In some embodiments, these features may first be segmented into a plurality of small chunks, so that multi-head self-attention can be used for each chunk, which enables each head to learn a different feature representation. In some embodiments, results of the multi-head processing may be merged, and then the segmented features may be fused by a linear transformation layer to obtain fused time-domain and frequency-domain features.

At the block 206, separated audio is generated by a decoder based on the fused feature, where the separate audio includes at least one of dry vocal audio or reverberant vocal audio. With continued reference to FIG. 1, when the fused time-domain and frequency-domain features are obtained, the decoder 124 may output separated audio. In some embodiments, if the audio separation model 120 is dedicated to separating reverberant audio, the reverberant vocal audio 130 may be obtained by the audio separation model 120. Conversely, if the audio separation model 120 is dedicated to separating dry audio, the dry vocal audio 140 may be obtained by the audio separation model 120. Alternatively, by inputting the wet vocal audio 110 into the audio separation model 120, the reverberant vocal audio 130 and the dry vocal audio 140 can also be obtained simultaneously.

Through the audio separation manner with an attention mechanism, an ability of an audio separation model to distinguish between a vocal component and a reverberation component can be enhanced, thereby improving accuracy of separating a vocal and reverberation from a vocal audio track. In addition, in this audio-based separation method, separated reverberant audio or separated dry vocal audio can be kept with sound quality close to that of vocal audio while audio is successfully separated, thereby improving user experience.

FIG. 3 is a flowchart of an example process 300 for audio separation according to an embodiment of the present disclosure. Referring to FIG. 3, a short-time Fourier transform may be first performed on original audio to be separated (i.e., the wet vocal audio 110 shown in FIG. 1) at 302 to obtain an expression of the original audio in a time-frequency domain, thereby facilitating extraction of more time-frequency-domain information of the original audio. After expression information of the original audio in the time-frequency domain is obtained, the expression information in the time-frequency domain may be sent to an encoder 310 in the audio separation model. In some embodiments, the encoder 122 includes a 2D convolutional layer 311 and two layers of feature processing modules, where one layer of feature processing module includes an inverse time-frequency convolution block-time-distributed fully connected layer 312 and a down-sampling layer 313, and the other layer of feature processing module includes an inverse time-frequency convolution block-time-distributed fully connected layer 314 and a down-sampling layer 315.

In some embodiments, to capture changes in an audio signal at different frequencies over a short period of time, a local time-domain feature (i.e., a first time-domain feature) of a wet audio signal of a vocal may be first extracted by the 2D convolutional layer 311. In some embodiments, Batch Normalization and a ReLU activation function (or another non-linear activation function) may follow the 2D convolutional layer, which can ensure training stability of the audio separation model.

In some embodiments, after the local time-domain feature is extracted, a time-domain feature (i.e., a second time-domain feature) may be further extracted by an inverse time-frequency convolution block (TFC) at the inverse time-frequency convolution block-time-distributed fully connected layer 312. In some embodiments, the inverse time-frequency convolution block (TFC) is a specially designed convolution operation that can be used to simultaneously process features in time and frequency dimensions, and can further extract feature information in a time-frequency domain in wet vocal audio, thereby helping the audio separation model to better understand a characteristic and a structure of a sound.

In some embodiments, a frequency-domain feature (i.e., a first frequency-domain feature) may also be extracted by a time-distributed fully connected layer (TDF) at the inverse time-frequency convolution block-time-distributed fully connected layer 312. In some embodiments, the time-distributed fully connected layer (TDF) may be a plurality of linear layers connected in series, which may obtain, for a frequency-domain signal in given wet vocal audio, a dependency relationship between spectrums of a target signal, thereby expanding a respective filed and enhancing an ability of the audio separation model to process a long audio material.

In some embodiments, the down-sampling layer 313 may obtain a first down-sampled feature. It may be understood that the first down-sampled feature herein includes a time-domain feature and a frequency-domain feature. In some embodiments, the first down-sampled feature herein may be an audio feature of a higher level and a lower dimension. Similarly, to further learn a dependency relationship between time-domain and frequency-domain features in a long audio material, the first down-sampled feature may also be input into the inverse time-frequency convolution block-time-distributed fully connected layer 314 and the down-sampling layer 315 to obtain a second down-sampled feature.

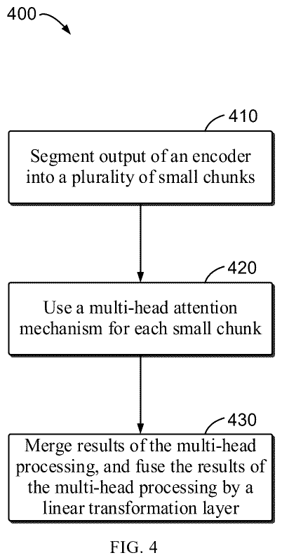

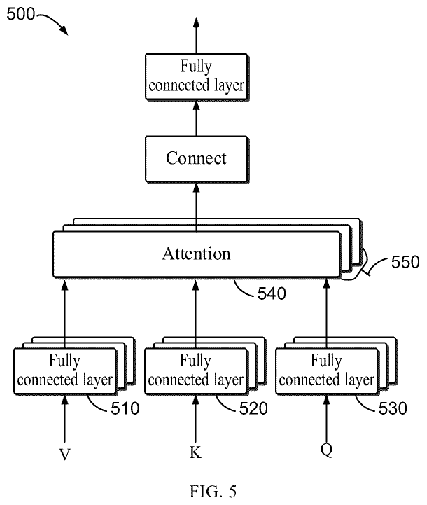

With continued reference to FIG. 3, after the second down-sampled feature including a time-domain feature and a frequency-domain feature is obtained, the second down-sampled feature may be injected into the network 126 with an attention mechanism to obtain a deeply-fused fused feature. For example, the audio separation model 120 may learn the input second down-sampled feature by using a multi-head attention layer 322 in the network 126 with an attention mechanism. Description is provided below in conjunction with FIG. 4 and FIG. 5. FIG. 4 is a schematic diagram of an example 400 in which a fused feature is obtained by a network with a multi-head attention mechanism according to some embodiments of the present disclosure. FIG. 5 is a schematic diagram of an example 500 of a network with a multi-head attention mechanism according to some embodiments of the present disclosure.

Referring to FIG. 4, in some embodiments, at 410, output (i.e., the second down-sampled feature) of the encoder may be segmented into a plurality of small chunks, for example, 16 small chunks. In conjunction with FIG. 5, an attention layer 540 has 16 heads 550. Therefore, at 420, a multi-head attention mechanism may be used for each small chunk, so that each head can learn a different representation of an input feature. A structure of the multi-head attention layer 322 may include a fully connected layer 510 used to receive a query vector (Q). The structure of the multi-head attention layer 322 may also include a fully connected layer 520 used to receive a key vector (K). The structure of the multi-head attention layer 322 may also include a fully connected layer 530 used to receive a numeric vector (V). It may be understood that each small chunk has its own query vector, key vector, and numeric vector. It may be understood that as input to the multi-head attention mechanism, the output of the encoder has been converted into a query vector, a key vector, and a numeric vector. A self-attention layer 540 may calculate an attention weight between each position and other positions and perform weighted summation on numeric vectors based on these weights. This process allows the audio separation model to take into account other positions in an entire sequence when processing is performed at each position, thereby enabling the audio separation model to capture a long-range dependency relationship, i.e., an ability to process a long audio material.

In conjunction with FIG. 4, after multi-head attention is used for each small chunk, at 430, results of the multi-head attention processing may be merged, and the results of the multi-head attention processing are fused by a linear layer. In conjunction with FIG. 5, output of the self-attention layer 540 may be sent to another fully connected layer for further processing. In some embodiments, this fully connected layer typically contains two linear transformations and one ReLU activation function, and aims to perform a further non-linear transformation and dimensional adjustment on the output of the attention layer 540 to generate a final fused feature.

Returning to FIG. 3, in some embodiments, a residual connection & layer normalization 324 may be added after the multi-head attention layer 322. Through the residual connection, a vanishing gradient problem in the network 126 with an attention mechanism can be mitigated. Similarly, through the layer normalization, the vanishing gradient problem and an exploding gradient problem can also be mitigated, thereby improving training stability of the audio separation model.

With continued reference to FIG. 3, to extract a higher-level fused feature, output of the layer normalization may be used as input to a Feedforward Network (FFN) 326. The feedforward network contains two linear transformations and one non-linear activation function (such as ReLU). A first linear transformation may map an input fused feature to a higher-dimension space to increase a non-linear expression ability, and a second linear transformation maps output back to an original dimension or a desired output dimension. To further mitigate the vanishing gradient problem and to facilitate the learning of a network structure at a deeper level by the audio separation model, a residual connection & layer normalization 328 may be performed on the higher-level fused feature again.

With continued reference to FIG. 3, the decoder 124 may gradually recover resolution in time and frequency domains based on the fused feature output by the network 126 with an attention mechanism, so that separated reverberant audio or separated dry audio can be finally obtained through a short-term inverse Fourier transform 352. In some embodiments, the decoder 124 includes two layers of feature processing modules and a 2D convolutional layer 335, where one layer of feature processing module includes an up-sampling layer 331 and an inverse time-frequency convolution block-time-distributed fully connected layer 332, and the other layer of feature processing modules includes an up-sampling layer 333 and an inverse time-frequency convolution block-time-distributed fully connected layer 334.

In some embodiments, a first time-domain feature and a first frequency-domain feature may be recovered stepwise by the up-sampling layer 331 and the inverse time-frequency convolution block-time-distributed fully connected layer 332. Similarly, a second time-domain feature and a second frequency-domain feature of the audio may be recovered by the up-sampling layer 333 and the inverse time-frequency convolution block-time-distributed fully connected layer 334. Next, a time-frequency-domain expression of the separated audio may be obtained by the 2D convolutional layer, and the separated audio may be obtained through a short-time inverse Fourier transform 352. In some embodiments, the decoder 124 may accept a feature at a corresponding encoding stage from the encoder 122 at each decoding stage via a skip connection 340, thereby helping the decoder 124 to recover detailed information of the audio. This can maintain separated reverberant vocal audio or separated dry vocal audio with sound quality similar to that of the wet vocal audio 110. In some embodiments, the audio separation model may have two output branches of the decoder, and therefore can simultaneously output separated reverberant audio and separated vocal audio. It may be understood that, a working process of the decoder 124 is the inverse of a working process of the encoder 122 and therefore is not be described herein.

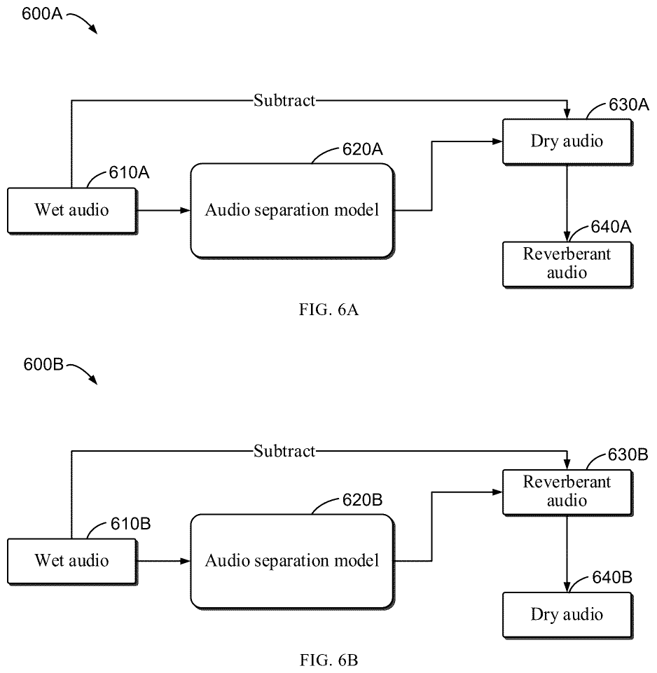

Description is provided below in conjunction with FIG. 6A and FIG. 6B. FIG. 6A and FIG. 6B are schematic diagrams of example processes 600A and 600B of obtaining dry audio or reverberant audio based on wet audio according to some embodiments of the present disclosure. Referring to FIG. 6A, if dry audio 630A is separated from wet audio 610A by an audio separation model 620A, reverberant audio 640A can be obtained by subtracting the dry audio 630A from the wet audio 610A. Conversely, referring to FIG. 6B, if reverberant audio 630B is separated from wet audio 610B by an audio separation model 620B, dry audio 640B can be obtained by subtracting the reverberant audio 630B from the wet audio 610B. It may be understood that a structure of a dry audio separation model is the same as that of a reverberant audio separation model, and loss functions can also be the same.

Through the audio separation manner with an attention mechanism, an ability of an audio separation model to distinguish between a vocal component and a reverberation component can be enhanced, thereby improving accuracy of separating a vocal and reverberation from a vocal audio track. In addition, in this audio-based separation method, separated reverberant audio or separated dry vocal audio can be kept with sound quality close to that of vocal audio while audio is successfully separated, thereby improving user experience.

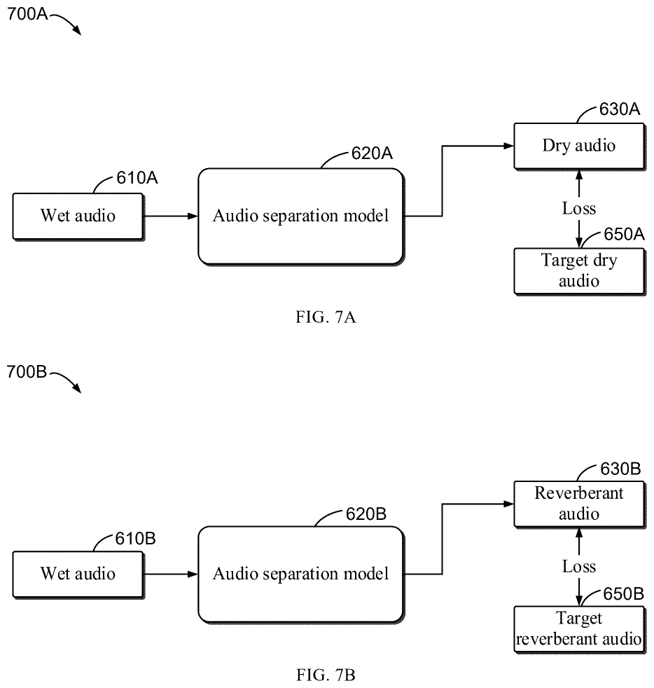

FIG. 7A is a schematic diagram of an example process 700A of training an audio separation model based on a loss between dry audio and target dry audio according to some embodiments of the present disclosure. Referring to FIG. 7A, to enable the audio separation model 620A to have accurate separation performance, parameters in the audio separation model 620A may be adjusted based on a loss between the dry audio 630A separated from the wet audio 610A and real target dry audio 650A. In some embodiments, L1 Loss (also known as Mean Absolute Error) may be used to calculate the loss between the separated dry audio 630A and the real target dry audio 650A.

FIG. 7B is a schematic diagram of an example process 700B of training an audio separation model based on a loss between reverberant audio and target reverberant audio according to some embodiments of the present disclosure. Referring to FIG. 7B, to enable the audio separation model 620B to have accurate separation performance, parameters in the audio separation model 620B may be adjusted based on a loss between the reverberant audio 630B separated from the wet audio 610B and real target reverberant audio 650B. In some embodiments, L1 Loss (also known as Mean Absolute Error) may also be used to calculate the loss between the separated reverberant audio 630B and the real target reverberant audio 650B.

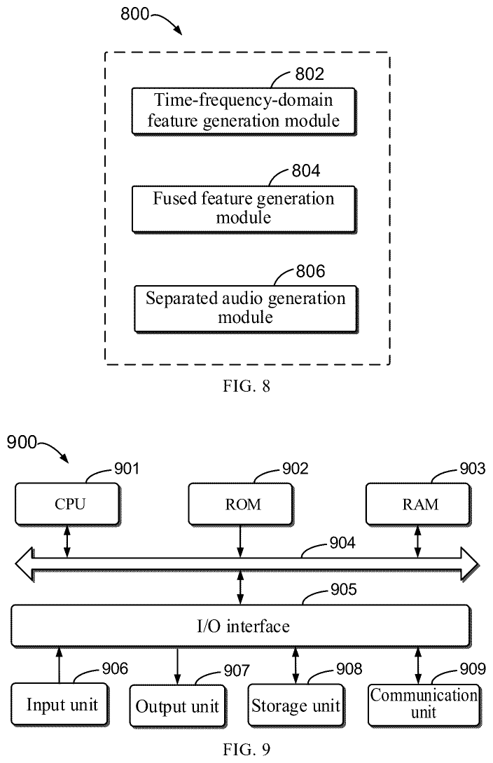

FIG. 8 is a block diagram of an apparatus 800 for audio separation according to some embodiments of the present disclosure. As shown in FIG. 8, the apparatus 800 includes a time-frequency-domain feature generation module 802 configured to generate, by an encoder, a time-domain feature and a frequency-domain feature of vocal audio based on the vocal audio. The apparatus 800 further includes a fused feature generation module 804 configured to generate, by a network with an attention mechanism, a fused feature based on the time-domain feature and the frequency-domain feature. In addition, the apparatus 800 further includes separated audio generation module 806 configured to generate, by a decoder, separated audio based on the fused feature, where the separated audio includes at least one of dry vocal audio or reverberant vocal audio.

FIG. 9 is a block diagram of a device 900 capable of implementing a plurality of embodiments of the present disclosure. The device 900 may be, for example, a processing unit of a picking robot 102 shown in FIG. 1. As shown in FIG. 9, the device 900 includes a central processing unit (CPU) and/or graphics processing unit (GPU) 901 that may perform a variety of appropriate actions and processing in accordance with computer program instructions stored in a read-only memory (ROM) 902 or computer program instructions loaded from a storage unit 908 into a random-access memory (RAM) 903. The RAM 903 may further store various programs and data required for the operation of the device 900. The CPU/GPU 901, the ROM 902, and the RAM 903 are connected to each other via a bus 904. An input/output (I/O) interface 905 is also connected to the bus 904. Although not shown in FIG. 9, the device 900 may further include a coprocessor.

A number of components in the device 900 are connected to the I/O interface 905, including: an input unit 906, such as a keyboard or a mouse; an output unit 907, such as various types of displays or speakers; the storage unit 908, such as a magnetic disk or an optical disk; and a communication unit 909, such as a network card, a modem, or a wireless communication transceiver. The communication unit 909 allows the device 900 to exchange information/data with other devices over a computer network such as the Internet and/or various telecommunication networks.

Each method or process described above may be performed by the CPU/GPU 901. For example, in some embodiments, the method may be implemented as a computer software program tangibly embodied in a machine-readable medium, such as the storage unit 908. In some embodiments, some or all of the computer programs may be loaded into and/or installed onto the device 900 via the ROM 902 and/or the communication unit 909. When the computer program is loaded into the RAM 903 and executed by the CPU/GPU 901, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowcharts and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowcharts and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowcharts and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The abovementioned descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

Some example implementations of the present disclosure are listed below.

Example 1. A method for audio separation, comprising:
generating, by an encoder, a time-domain feature and a frequency-domain feature of vocal audio based on the vocal audio;
generating, by a network with an attention mechanism, a fused feature based on the time-domain feature and the frequency-domain feature; and
generating, by a decoder, separated audio based on the fused feature, the separated audio comprising at least one of dry vocal audio or reverberant vocal audio.

Example 2. The method according to Example 1, the encoder comprising a convolutional layer and two layers of feature processing modules, the feature processing module comprising an inverse time-frequency convolution block-time-distributed fully connected layer and a down-sampling layer, and the generating, by an encoder, a time-domain feature and a frequency-domain feature of vocal audio based on the vocal audio comprises:
obtaining, by a first feature processing module, a first down-sampled feature based on the vocal audio, the first down-sampled feature comprising a first down-sampled time-domain feature and a first down-sampled frequency-domain feature.

Example 3. The method according to either of Examples 1 and 2, where the obtaining a first down-sampled feature based on the first feature processing module comprises:
extracting, by a convolutional layer of the first feature processing module, the time-domain feature of the vocal audio based on the vocal audio to obtain a first time-domain feature; and
extracting, by an inverse time-frequency convolution block of the first feature processing module, a second time-domain feature based on the first time-domain feature.

Example 4. The method according to any one of Examples 1 to 3, further comprising:
determining, by a time-distributed fully connected layer of the first feature processing module, the frequency-domain feature of the vocal audio based on the vocal audio, the time-distributed fully connected layer comprising a plurality of linear layers.

Example 5. The method according to any one of Examples 1 to 4, further comprising:
obtaining, by a down-sampling layer of the first feature processing module, the first down-sampled feature based on the second time-domain feature and the frequency-domain feature of the vocal audio.

Example 6. The method according to any one of Examples 1 to 5, a number of channels of the down-sampling layer of the first feature processing module being different from a number of channels of a down-sampling layer of a second feature processing module, and the method further comprises:
obtaining, by the second feature processing module, a second down-sampled feature based on the first down-sampled time-domain feature and the first down-sampled frequency-domain feature, the second down-sampled feature comprising a second down-sampled time-domain feature and a second sampled frequency-domain feature.

Example 7. The method according to any one of Examples 1 to 6, where the generating, by a network with an attention mechanism, a fused feature based on the time-domain feature and the frequency-domain feature comprises:
obtaining, by the network with an attention mechanism, the fused feature based on the second down-sampled feature.

Example 8. The method according to any one of Examples 1 to 7, where the obtaining, by the network with an attention mechanism, the fused feature based on the second down-sampled feature comprises:
segmenting the second down-sampled feature into a plurality of small chunks of down-sampled features;
using multi-head attention in parallel on the small chunks of down-sampled features to obtain multi-head self-attention results of the small chunks of down-sampled features; and
fusing the multi-head self-attention results of the small chunks of down-sampled features through a linear transformation to obtain the fused feature.

Example 9. The method according to any one of Examples 1 to 8, the decoder comprising two layers of feature transformation modules and a convolutional layer, the feature transformation module comprises an up-sampling layer and an inverse time-frequency convolution block-time-distributed fully connected layer, and the generating, by a decoder, separated audio based on the fused feature comprises:
obtaining, by a first feature transformation module, a first frequency-domain feature of the separated audio and a first time-domain feature of the separated audio based on the fused feature;
obtaining, by a second feature transformation module, a second frequency-domain feature of the separated audio and a second time-domain feature of the separated audio based on the first frequency-domain feature of the separated audio and the first time-domain feature of the separated audio; and
obtaining, by the convolutional layer, the separated audio based on the second frequency-domain feature of the separated audio and the second time-domain feature of the separated audio.

Example 10. The method according to any one of Examples 1 to 9, further comprising:
training an audio separation model based on a loss between the separated audio and real target separated audio, the audio separation model comprising the encoder, the network with an attention mechanism, and the decoder.

Example 11. The method according to any one of Examples 1 to 10, further comprising:
obtaining the vocal audio, and performing a short-time Fourier transform on the vocal audio to obtain an expression of the vocal audio in a time-frequency domain.

Example 12. The method according to any one of Examples 1 to 11, further comprising:
determining the dry vocal audio based on the vocal audio and the reverberant vocal audio in response to the separated audio being the reverberant vocal audio; or
determining the reverberant vocal audio based on the vocal audio and the dry vocal audio in response to the separated audio being the dry vocal audio.

Example 13. An apparatus for audio separation, comprising:
a time-frequency-domain feature generation module configured to generate, by an encoder, a time-domain feature and a frequency-domain feature of vocal audio based on the vocal audio;
a fused feature generation module configured to generate, by a network with an attention mechanism, a fused feature based on the time-domain feature and the frequency-domain feature; and
a separated audio generation module configured to generate, by a decoder, separated audio based on the fused feature, the separated audio comprising at least one of dry vocal audio or reverberant vocal audio.

Example 14. The apparatus according to Example 13, the encoder comprising a convolutional layer and two layers of feature processing modules, the feature processing module comprising an inverse time-frequency convolution block-time-distributed fully connected layer and a down-sampling layer, and the time-frequency-domain feature generation module comprises:
a first obtaining module configured to obtain, by a first feature processing module, a first down-sampled feature based on the vocal audio, the first down-sampled feature comprising a first down-sampled time-domain feature and a first down-sampled frequency-domain feature.

Example 15. The apparatus according to either of Examples 13 and 14, where the first obtaining module comprises:
a second obtaining module configured to extract, by a convolutional layer of the first feature processing module, the time-domain feature of the vocal audio based on the vocal audio to obtain a first time-domain feature; and
a first extraction module configured to extract, by an inverse time-frequency convolution block of the first feature processing module, a second time-domain feature based on the first time-domain feature.

Example 16. The apparatus according to any one of Examples 13 to 15, further comprising:
a first determining module configured to determine, by a time-distributed fully connected layer of the first feature processing module, the frequency-domain feature of the vocal audio based on the vocal audio, the time-distributed fully connected layer comprising a plurality of linear layers.

Example 17. The apparatus according to any one of Examples 13 to 16, further comprising:
a third obtaining module configured to obtain, by a down-sampling layer of the first feature processing module, the first down-sampled feature based on the second time-domain feature and the frequency-domain feature of the vocal audio.

Example 18. The apparatus according to any one of Examples 13 to 17, a number of channels of the down-sampling layer of the first feature processing module being different from a number of channels of a down-sampling layer of a second feature processing module, and the apparatus further comprises:
a fourth obtaining module configured to obtain, by the second feature processing module, a second down-sampled feature based on the first down-sampled time-domain feature and the first down-sampled frequency-domain feature, the second down-sampled feature comprising a second down-sampled time-domain feature and a second sampled frequency-domain feature.

Example 19. The apparatus according to any one of Examples 13 to 18, where the fused feature generation module comprises:
a fifth obtaining module configured to obtain, by the network with an attention mechanism, the fused feature based on the second down-sampled feature.

Example 20. The apparatus according to any one of Examples 13 to 19, where the fifth obtaining module comprises:
a segmentation module configured to segment the second down-sampled feature into a plurality of small chunks of down-sampled features;
a sixth obtaining module configured to use multi-head attention in parallel on the small chunks of down-sampled features to obtain multi-head self-attention results of the small chunks of down-sampled features; and
a seventh obtaining module configured to fuse the multi-head self-attention results of the small chunks of down-sampled features through a linear transformation to obtain the fused feature.

Example 21. The apparatus according to any one of Examples 13-20, the decoder comprising two layers of feature transformation modules and a convolutional layer, the feature transformation module comprises an up-sampling layer and an inverse time-frequency convolution block-time-distributed fully connected layer, and the separated audio generation module comprises:
an eighth obtaining module configured to obtain, by a first feature transformation module, a first frequency-domain feature of the separated audio and a first time-domain feature of the separated audio based on the fused feature;
a ninth obtaining module configured to obtain, by a second feature transformation module, a second frequency-domain feature of the separated audio and a second time-domain feature of the separated audio based on the first frequency-domain feature of the separated audio and the first time-domain feature of the separated audio; and
a tenth obtaining module configured to obtain, by the convolutional layer, the separated audio based on the second frequency-domain feature of the separated audio and the second time-domain feature of the separated audio.

Example 22. The apparatus according to any one of Examples 13 to 21, further comprising:
a training module configured to train an audio separation model based on a loss between the separated audio and real target separated audio, the audio separation model comprising the encoder, the network with an attention mechanism, and the decoder.

Example 23. The apparatus according to any one of Examples 13 to 22, further comprising:
an eleventh obtaining module configured to obtain the vocal audio and perform a short-time Fourier transform on the vocal audio to obtain an expression of the vocal audio in a time-frequency domain.

Example 24. The apparatus according to any one of Examples 13 to 23, further comprising:
a second determining module configured to determine the dry vocal audio based on the vocal audio and the reverberant vocal audio in response to the separated audio being the reverberant vocal audio; or
a third determining module configured to determine the reverberant vocal audio based on the vocal audio and the dry vocal audio in response to the separated audio being the dry vocal audio.

Example 25. An electronic device, comprising:
a processor; and
a memory coupled to the processor, where the memory has stored therein instructions that, when executed by the processor, cause the electronic device to perform actions comprising:

generating, by an encoder, a time-domain feature and a frequency-domain feature of vocal audio based on the vocal audio;
generating, by a network with an attention mechanism, a fused feature based on the time-domain feature and the frequency-domain feature; and
generating, by a decoder, separated audio based on the fused feature, the separated audio comprising at least one of dry vocal audio or reverberant vocal audio.

Example 26. The electronic device according to Examples 25, the encoder comprising a convolutional layer and two layers of feature processing modules, the feature processing module comprising an inverse time-frequency convolution block-time-distributed fully connected layer and a down-sampling layer, and the generating, by an encoder, a time-domain feature and a frequency-domain feature of vocal audio based on the vocal audio comprises:
obtaining, by a first feature processing module, a first down-sampled feature based on the vocal audio, the first down-sampled feature comprising a first down-sampled time-domain feature and a first down-sampled frequency-domain feature.

Example 27. The electronic device according to any one of Examples 25 to 26, where the obtaining a first down-sampled feature based on the first feature processing module comprises:
extracting, by a convolutional layer of the first feature processing module, the time-domain feature of the vocal audio based on the vocal audio to obtain a first time-domain feature; and
extracting, by an inverse time-frequency convolution block of the first feature processing module, a second time-domain feature based on the first time-domain feature.

Example 28. The electronic device according to any one of Examples 25 to 27, further comprising:
determining, by a time-distributed fully connected layer of the first feature processing module, the frequency-domain feature of the vocal audio based on the vocal audio, the time-distributed fully connected layer comprising a plurality of linear layers.

Example 29. The electronic device according to any one of Examples 25 to 28, further comprising:
obtaining, by a down-sampling layer of the first feature processing module, the first down-sampled feature based on the second time-domain feature and the frequency-domain feature of the vocal audio.

Example 30. The electronic device according to any one of Examples 25-29, a number of channels of the down-sampling layer of the first feature processing module being different from a number of channels of a down-sampling layer of a second feature processing module, and the actions further comprise:
obtaining, by the second feature processing module, a second down-sampled feature based on the first down-sampled time-domain feature and the first down-sampled frequency-domain feature, the second down-sampled feature comprising a second down-sampled time-domain feature and a second sampled frequency-domain feature.

Example 31. The electronic device according to any one of Examples 25 and 30, where the generating, by a network with an attention mechanism, a fused feature based on the time-domain feature and the frequency-domain feature comprises:
obtaining, by the network with an attention mechanism, the fused feature based on the second down-sampled feature.

Example 32. The electronic device according to any one of Examples 25 and 31, where the obtaining, by the network with an attention mechanism, the fused feature based on the second down-sampled feature comprises:
segmenting the second down-sampled feature into a plurality of small chunks of down-sampled features;
using multi-head attention in parallel on the small chunks of down-sampled features to obtain multi-head self-attention results of the small chunks of down-sampled features; and
fusing the multi-head self-attention results of the small chunks of down-sampled features through a linear transformation to obtain the fused feature.

Example 33. The electronic device according to any one of Examples 25 and 32, the decoder comprising two layers of feature transformation modules and a convolutional layer, the feature transformation module comprises an up-sampling layer and an inverse time-frequency convolution block-time-distributed fully connected layer, and the generating, by a decoder, separated audio based on the fused feature comprises:
obtaining, by a first feature transformation module, a first frequency-domain feature of the separated audio and a first time-domain feature of the separated audio based on the fused feature;
obtaining, by a second feature transformation module, a second frequency-domain feature of the separated audio and a second time-domain feature of the separated audio based on the first frequency-domain feature of the separated audio and the first time-domain feature of the separated audio; and
obtaining, by the convolutional layer, the separated audio based on the second frequency-domain feature of the separated audio and the second time-domain feature of the separated audio.

Example 34. The electronic device according to any one of Examples 25 to 33, further comprising:
training an audio separation model based on a loss between the separated audio and real target separated audio, the audio separation model comprising the encoder, the network with an attention mechanism, and the decoder.

Example 35. The electronic device according to any one of Examples 25 to 34, further comprising:
obtaining the vocal audio, and performing a short-time Fourier transform on the vocal audio to obtain an expression of the vocal audio in a time-frequency domain.

Example 36. The electronic device according to any one of Examples 25 to 35, further comprising:
determining the dry vocal audio based on the vocal audio and the reverberant vocal audio in response to the separated audio being the reverberant vocal audio; or
determining the reverberant vocal audio based on the vocal audio and the dry vocal audio in response to the separated audio being the dry vocal audio.

Example 37. A computer-readable storage medium having stored thereon computer-executable instructions, where the computer executable instructions are executed by a processor to implement the method according to any one of Examples 1 to 12.

Example 38. A computer program product tangibly stored on a computer-readable medium and comprising computer-executable instructions that, when executed by a device, cause the device to perform the method according to any one of Examples 1 to 12.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for audio separation, comprising:
generating, by an encoder, a time-domain feature and a frequency-domain feature of vocal audio based on the vocal audio;
generating, by a network with an attention mechanism, a fused feature based on the time-domain feature and the frequency-domain feature; and
generating, by a decoder, separated audio based on the fused feature, the separated audio comprising at least one of dry vocal audio or reverberant vocal audio.

2. The method according to claim 1, the encoder comprising a convolutional layer and two layers of feature processing modules, the feature processing module comprising an inverse time-frequency convolution block-time-distributed fully connected layer and a down-sampling layer, and the generating, by an encoder, a time-domain feature and a frequency-domain feature of vocal audio based on the vocal audio comprises:
obtaining, by a first feature processing module, a first down-sampled feature based on the vocal audio, the first down-sampled feature comprising a first down-sampled time-domain feature and a first down-sampled frequency-domain feature.

3. The method according to claim 2, wherein the obtaining a first down-sampled feature based on the first feature processing module comprises:
extracting, by a convolutional layer of the first feature processing module, the time-domain feature of the vocal audio based on the vocal audio to obtain a first time-domain feature; and
extracting, by an inverse time-frequency convolution block of the first feature processing module, a second time-domain feature based on the first time-domain feature.

4. The method according to claim 3, further comprising:
determining, by a time-distributed fully connected layer of the first feature processing module, the frequency-domain feature of the vocal audio based on the vocal audio, the time-distributed fully connected layer comprising a plurality of linear layers.

5. The method according to claim 4, further comprising:
obtaining, by a down-sampling layer of the first feature processing module, the first down-sampled feature based on the second time-domain feature and the frequency-domain feature of the vocal audio.

6. The method according to claim 5, a number of channels of the down-sampling layer of the first feature processing module being different from a number of channels of a down-sampling layer of a second feature processing module, and the method further comprises:
obtaining, by the second feature processing module, a second down-sampled feature based on the first down-sampled time-domain feature and the first down-sampled frequency-domain feature, the second down-sampled feature comprising a second down-sampled time-domain feature and a second sampled frequency-domain feature.

7. The method according to claim 6, wherein the generating, by a network with an attention mechanism, a fused feature based on the time-domain feature and the frequency-domain feature comprises:
obtaining, by the network with an attention mechanism, the fused feature based on the second down-sampled feature.

8. The method according to claim 7, wherein the obtaining, by the network with an attention mechanism, the fused feature based on the second down-sampled feature comprises:
segmenting the second down-sampled feature into a plurality of small chunks of down-sampled features;
using multi-head attention in parallel on the small chunks of down-sampled features to obtain multi-head self-attention results of the small chunks of down-sampled features; and
fusing the multi-head self-attention results of the small chunks of down-sampled features through a linear transformation to obtain the fused feature.

9. The method according to claim 8, the decoder comprising two layers of feature transformation modules and a convolutional layer, the feature transformation module comprising an up-sampling layer and an inverse time-frequency convolution block-time-distributed fully connected layer, and the generating, by a decoder, separated audio based on the fused feature comprises:
obtaining, by a first feature transformation module, a first frequency-domain feature of the separated audio and a first time-domain feature of the separated audio based on the fused feature;
obtaining, by a second feature transformation module, a second frequency-domain feature of the separated audio and a second time-domain feature of the separated audio based on the first frequency-domain feature of the separated audio and the first time-domain feature of the separated audio; and
obtaining, by the convolutional layer, the separated audio based on the second frequency-domain feature of the separated audio and the second time-domain feature of the separated audio.

10. The method according to claim 9, further comprising:
training an audio separation model based on a loss between the separated audio and real target separated audio, the audio separation model comprising the encoder, the network with an attention mechanism, and the decoder.

11. The method according to claim 1, further comprising:
obtaining the vocal audio, and performing a short-time Fourier transform on the vocal audio to obtain an expression of the vocal audio in a time-frequency domain.

12. The method according to claim 1, further comprising:
determining the dry vocal audio based on the vocal audio and the reverberant vocal audio in response to the separated audio being the reverberant vocal audio; or
determining the reverberant vocal audio based on the vocal audio and the dry vocal audio in response to the separated audio being the dry vocal audio.

13. An electronic device, comprising:
a processor; and
a memory coupled to the processor, wherein the memory has stored therein instructions that, when executed by the processor, cause the electronic device to:
generate, by an encoder, a time-domain feature and a frequency-domain feature of vocal audio based on the vocal audio;
generate, by a network with an attention mechanism, a fused feature based on the time-domain feature and the frequency-domain feature; and
generate, by a decoder, separated audio based on the fused feature, the separated audio comprising at least one of dry vocal audio or reverberant vocal audio.

14. The device according to claim 13, the encoder comprising a convolutional layer and two layers of feature processing modules, the feature processing module comprising an inverse time-frequency convolution block-time-distributed fully connected layer and a down-sampling layer, and wherein the instructions causing the processor to generate, by an encoder, a time-domain feature and a frequency-domain feature of vocal audio based on the vocal audio comprise instructions causing the processor to:
obtain, by a first feature processing module, a first down-sampled feature based on the vocal audio, the first down-sampled feature comprising a first down-sampled time-domain feature and a first down-sampled frequency-domain feature.

15. The device according to claim 14, wherein the instructions causing the processor to obtain a first down-sampled feature based on the first feature processing module comprise instructions causing the processor to:
extract, by a convolutional layer of the first feature processing module, the time-domain feature of the vocal audio based on the vocal audio to obtain a first time-domain feature; and
extract, by an inverse time-frequency convolution block of the first feature processing module, a second time-domain feature based on the first time-domain feature.

16. The device according to claim 15, further comprising instructions causing the processor to:
determine, by a time-distributed fully connected layer of the first feature processing module, the frequency-domain feature of the vocal audio based on the vocal audio, the time-distributed fully connected layer comprising a plurality of linear layers.

17. The device according to claim 16, further comprising instructions causing the processor to:
obtain, by a down-sampling layer of the first feature processing module, the first down-sampled feature based on the second time-domain feature and the frequency-domain feature of the vocal audio.

18. The device according to claim 17, a number of channels of the down-sampling layer of the first feature processing module being different from a number of channels of a down-sampling layer of a second feature processing module, and further comprising instructions causing the processor to:
obtain, by the second feature processing module, a second down-sampled feature based on the first down-sampled time-domain feature and the first down-sampled frequency-domain feature, the second down-sampled feature comprising a second down-sampled time-domain feature and a second sampled frequency-domain feature.

19. The device according to claim 18, wherein the instructions causing the processor to generate, by a network with an attention mechanism, a fused feature based on the time-domain feature and the frequency-domain feature comprise instructions causing the processor to:
obtain, by the network with an attention mechanism, the fused feature based on the second down-sampled feature.

20. A non-transitory computer-readable medium comprising instructions stored thereon which, when executed by a processor, cause the processor to:
generate, by an encoder, a time-domain feature and a frequency-domain feature of vocal audio based on the vocal audio;
generate, by a network with an attention mechanism, a fused feature based on the time-domain feature and the frequency-domain feature; and
generate, by a decoder, separated audio based on the fused feature, the separated audio comprising at least one of dry vocal audio or reverberant vocal audio.
